(19) United States
(12) Patent Application Publication
(10) Pub. No.: US 2002/0185026 A1
(43) Pub. Date: Dec. 12, 2002

(54) Sleeve for a cylinder of a printing machine

(76) Inventor: Udo Drager, Speyer (DE)

Correspondence Address: Lawrence P. Kessler, NexPress Solutions LLC, Patent Department, 1447 St. Paul Street, Rochester, NY, 14653-7103, US

(21) Appl. No.: 10/161,842

(22) Filed: Jun. 4, 2002

(30) Foreign Application Priority Data
Jun. 8, 2001 (DE) 101 27 912.4

(51) Int. Cl. B41F 13/10

(52) U.S. Cl. 101/375

(57) ABSTRACT

A high-precision cylinder for a printing machine provides a sleeve for a cylinder of a printing machine made out of a plastic material, which includes an electrically conducting layer on the plastic material, and a layer made of a metallic material on the electrically conducting layer.

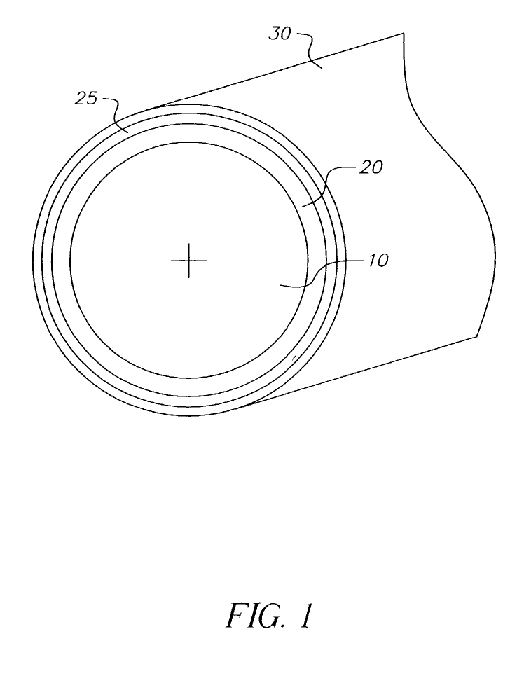

### FIELD OF THE INVENTION

The invention involves a sleeve for a cylinder of a printing machine.

### BACKGROUND OF THE INVENTION

Different cylinders of printing machines have coatings that perform certain functions. For example, the rubber blanket (offset blanket) cylinder, which is used especially in offset printing, and the fixing roller for fixing the printing toner on the printed material in another printing step in the printer are usually coated with an elastomer. In electrophotographic printing, the image-generating cylinder or imaging drum is often coated with an organic photoconductor, on which the latent image is stored. Of great significance for the prevention of image defects and for the quality of the printed result, for example, in the case of the imaging drum in electrophotographic printing, is the formation of its surface with high precision. Because of the wear and tear on the surface of the imaging drum, the imaging drum is replaced from time to time. The high-precision imaging drum and the maintenance expense associated with the replacement, however, is costly. A known solution thus proposes providing the imaging drum with metal-coated plastic sleeves, whose surface fulfills the image-generating task of the imaging drum. If the surface is worn, only the plastic sleeve is replaced, the imaging drum stays held and continues to be used as a substrate of the new sleeve. GB 2051681 discloses a printing roller with a plastic sleeve that carries an outer layer made of metal. The manufacturing process of this sleeve, however, is expensive and cost-intensive. Furthermore, the known sleeves have too large unevennesses for some printing requirements, and in particular seams for the ends of the sleeves usually joined by welding.

### SUMMARY OF THE INVENTION

For this reason, one purpose of this invention is to prepare, in a cost-effective manner, a high-precision cylinder in a printing machine. According to the invention, the purpose is readily achieved whereby a sleeve is made out of a plastic material, has an electrically conductive layer and an applied coating made out of a metallic material on the electrically conducting layer.

The invention, and its objects and advantages, will become more apparent in the detailed description of the preferred embodiment presented below.

### BRIEF DESCRIPTION OF THE DRAWINGS

In the detailed description of the preferred embodiment of the invention presented below, reference is made to the accompanying drawing, which shows, in perspective, a cross-section view of the sleeve, according to the invention, for a printing machine cylinder.

### DETAILED DESCRIPTION OF THE INVENTION

The drawing shows a cross-section of a sleeve 20 around a cylinder 10 for a printing machine. The cylinder 10 is, in an exemplary process, an image-generating cylinder or imaging drum in an electrophotographic printing machine. The cylinder 10 functions for the purpose of recording latent images in the form of electrostatic charges, on which toner material adheres, and in passing such toner-developed latent images to a printed material via another roller, whereby the image to be printed results. The cylinder 10 can be manufactured out of metal without high requirements for its surface smoothness.

A cylinder sleeve or sleeve 20 is located on the cylinder 10. This sleeve is connected with the cylinder 10 so that it can detach, whereby the cylinder 10 can be additionally reused for additional printing operations. The sleeve 20 is manufactured out of plastic by the shaping process of extrusion. In this process, a homogenous plastic granulate, preferably polyethylene or polyester, is melted in an extruder, conveyed and then shaped in a screw cylinder. A conductive material such as a carbon-containing material, preferably carbon black, or metallic powder, is added to the polyethylene or polyester as a base material of the sleeve 20. In this way, the plastic has an electric conductivity. Without the addition of carbon-containing material, the plastics polyacethylene, polypyrrol, polyaniline or polythiophene can be used, which have their own sufficient conductivity. On the plastic sleeve 20 an electrically conducting layer 25 is mounted, which preferably consists of polycarbonate. On the electrically conducting layer 25, a coating 30 is applied using a sputtering process.

In the coating process of the sputtering, a strong electric field is prepared in a vacuum space near electrodes of a material generator, a metallic or ceramic material such as, for example, chromium, aluminum, or gold. The target (i.e., conducting layer 25) is bombarded with ions from a surrounding gas plasma of a plasma generator, whereby particles of the electrode material are detached or struck free, which then accumulate on the electrically conductive layer 25 and form the coating 30. In the preferred example, the bombarded material is chromium, whose particles released by being struck accumulate on the surface of the electrically conducting layer 25 and form a coating 30. The electrodes can be constructed in a planar manner, whereby the cylinder 10 with the sleeve 20 and the electrically conductive layer 25 rotates uniformly between the electrodes around its longitudinal axis and is impinged uniformly by chromium particles that have been struck free. Alternatively, the two electrodes are constructed so that they are curved and together form almost a circle, whereby the cylinder 10 need not be turned with the sleeve 20 and the electrically conductive layer 25.

The sputtering process, until now, has mainly been applied in the semi-conductor technology. The sleeve 20 for mounting onto a cylinder of a printing machine with the electrically conducting layer 25 made of polycarbonate and the sputtered-on coating 30 has a smooth surface, which is suited in a particular manner for the use in printing technology. To be mentioned is that the invention substantially prevents the prior art disadvantages of unevennesses or seams on the joined position of the ends of the sleeve that is finished and formed into a pipe. This sleeve construction thus substantially prevents printing blurs in the known prior art sleeves.

The invention has been described in detail with particular reference to certain preferred embodiments thereof, but it will be understood that variations and modifications can be effected within the spirit and scope of the invention.

What is claimed is:

1. Sleeve (20) for a cylinder (10) of a printing machine, characterized in that said sleeve (20) is made of a plastic material, an electrically conductive layer (25) on said plastic material, and a coating (30) made of a metallic material on said electrically conductive layer (25).

2. Sleeve (20) for a cylinder (10) of a printing machine according to claim 1, characterized in that the metallic material of said coating (30) contains chromium.

3. Sleeve (20) for a cylinder (10) of a printing machine according to claim 1, characterized in that the metallic material of said coating (30) contains gold.

4. Sleeve, (20) for a cylinder (10) of a printing machine according to claim 1, characterized in that the metallic material of said coating (30) contains aluminum.

5. Sleeve (20) for a cylinder (10) of a printing machine according to claim 1, characterized in that the plastic material of said sleeve (20) has electric conductivity.

6. Sleeve (20) for a cylinder (10) of a printing machine according to claim 5, characterized in that the plastic material of said sleeve (20) contains a carbon compound, in particular, carbon black.

7. Sleeve (20) for a cylinder (10) of a printing machine according to claim 5, characterized in that the plastic material of said sleeve (20) contains metallic powder.

8. Sleeve (20) for a cylinder (10) of a printing machine according to claim 1, characterized in that said sleeve (20) is manufactured by extrusion of said plastic material.

9. Sleeve (20) for a cylinder (10) of a printing machine according to claim 1, characterized in that said coating made out of a metallic material is applied by sputtering.
